(19) United States
(12) Patent Application Publication
(10) Pub. No.: US 2009/0210909 A1
(43) Pub. Date: Aug. 20, 2009

(54) Internet Media Via an Electronic Programming Guide

(75) Inventors: Ankur Mukerji, Austin, TX (US); Charles Scott, Austin, TX (US); Scott White, Austin, TX (US)

Correspondence Address: AT&T Legal Department - LNAP;Attn: Patent Docketing, Room 2A- 207, One AT & T Way, Bedminster, NJ, 07921, US

(73) Assignee: AT&T INTELLECTUAL PROPERTY, LP, Reno, NV (US)

(21) Appl. No.: 12/034,453

(22) Filed: Feb. 20, 2008

(51) Int. Cl. H04N 5/445

(52) U.S. Cl. 725/51

(57) ABSTRACT

A set top box includes a processor configured to provide an electronic programming guide to available television programming, and list content available from the Internet within the electronic programming guide.

### FIELD OF THE DISCLOSURE

The present disclosure generally relates to communications networks, and more particularly relates to systems and methods for providing Internet media via electronic programming guide.

### BACKGROUND

When watching television, viewers enjoy a variety of channel and viewing options. An Electronic Programming Guide (EPG) allows the viewer to see broadcast schedules for available channels. To better aid in identifying programming, the EPG may also provide descriptions of scheduled shows. Further, the EPG may provide the viewer with extended broadcast schedules, such as over the next days or weeks, allowing the viewer to identify content for later viewing or recording.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating an Internet Protocol Television (IPTV) network in accordance with one embodiment of the present disclosure;

FIG. 2 is a schematic view of an exemplary electronic programming guide;

FIG. 3 is a schematic view of an exemplary electronic programming guide showing Internet content channels;

FIG. 4 is a flow diagram of an exemplary method for accessing Internet content;

FIG. 5 is a schematic view of an exemplary embodiment of an interface to add an Internet content channel; and

FIG. 6 is an illustrative embodiment of a general computer system.

The use of the same reference symbols in different drawings indicates similar or identical items.

### DETAILED DESCRIPTION OF THE DRAWINGS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others.

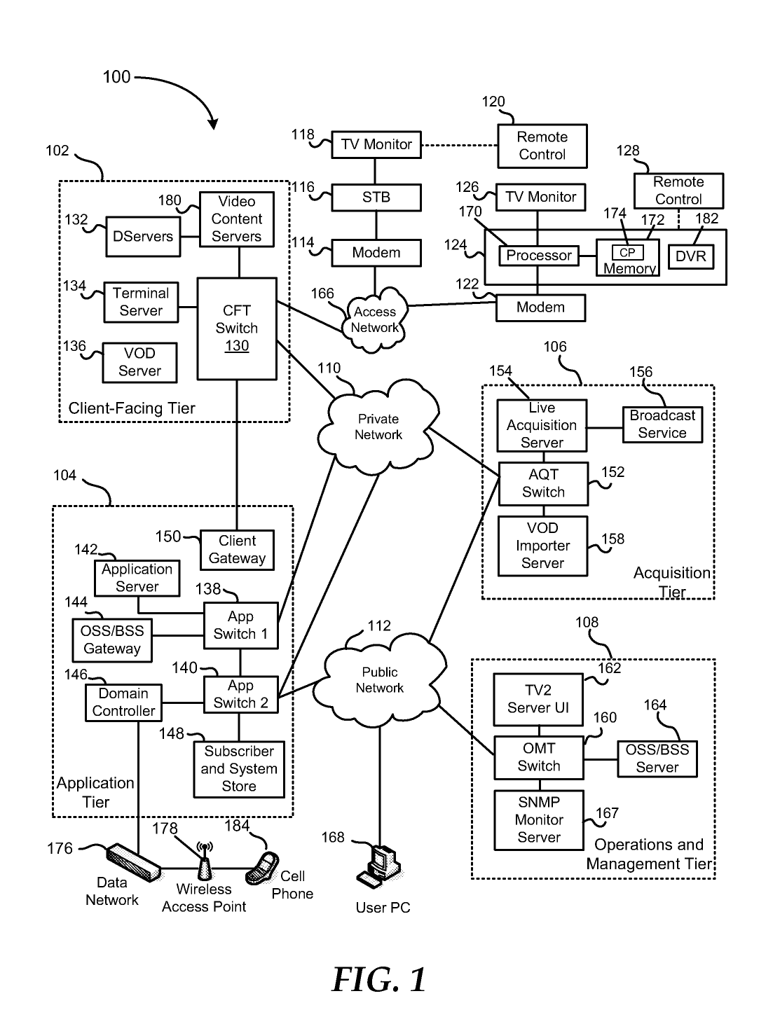

FIG. 1 shows an Internet Protocol Television (IPTV) system 100 including a client facing tier 102, an application tier 104, an acquisition tier 106, and an operations and management tier 108. Each tier 102, 104, 106, and 108 is coupled to one or both of a private network 110 and a public network 112. For example, the client-facing tier 102 can be coupled to the private network 110, while the application tier 104 can be coupled to the private network 110 and to the public network 112 such as the Internet. The acquisition tier 106 can also be coupled to the private network 110 and to the public network 112. Moreover, the operations and management tier 108 can be coupled to the public network 112.

The various tiers 102, 104, 106 and 108 communicate with each other via the private network 110 and the public network 112. For instance, the client-facing tier 102 can communicate with the application tier 104 and the acquisition tier 106 via the private network 110. The application tier 104 can also communicate with the acquisition tier 106 via the private network 110. Further, the application tier 104 can communicate with the acquisition tier 106 and the operations and management tier 108 via the public network 112. Moreover, the acquisition tier 106 can communicate with the operations and management tier 108 via the public network 112. In a particular embodiment, elements of the application tier 104 can communicate directly with the client-facing tier 102.

The client-facing tier 102 can communicate with user equipment via a private access network 166, such as an IPTV network. In an illustrative embodiment, modems such as a first modem 114 and a second modem 122 can be coupled to the private access network 166. The client-facing tier 102 can communicate with a first representative set-top box (STB) device 116 via the first modem 114 and with a second representative set-top box device 124 via the second modem 122. The client-facing tier 102 can communicate with a large number of set-top boxes over a wide geographic area, such as a regional area, a metropolitan area, a viewing area, or any other suitable geographic area that can be supported by networking the client-facing tier 102 to numerous set-top box devices. In one embodiment, the client-facing tier 102 can be coupled to the modems 114 and 122 via fiber optic cables. Alternatively, the modems 114 and 122 can be digital subscriber line (DSL) modems that are coupled to one or more network nodes via twisted pairs, and the client-facing tier 102 can be coupled to the network nodes via fiber-optic cables. Each set-top box device 116 and 124 can process data received from the private access network 166 via an IPTV software platform such as Microsoft® TV IPTV Edition.

The first set-top box device 116 can be coupled to a first display device 118, such as a first television monitor, and the second set-top box device 124 can be coupled to a second display device 126, such as a second television monitor. Moreover, the first set-top box device 116 can communicate with a first remote control 120, and the second set-top box device can communicate with a second remote control 128. In an exemplary, non-limiting embodiment, each set-top box device 116 and 124 can receive data or video from the client-facing tier 102 via the private access network 166 and render or display the data or video at the display device 118 or 126 to which it is coupled. The set-top box devices 116 and 124 thus may include tuners that receive and decode television programming information for transmission to the display devices 118 and 126. Further, the set-top box devices 116 and 124 can include an STB processor 170 and an STB memory device 172 that is accessible to the STB processor. In a particular embodiment, the set-top box devices 116 and 124 can also communicate commands received from the remote controls 120 and 128 back to the client-facing tier 102 via the private access network 166.

In an illustrative embodiment, the client-facing tier 102 can include a client-facing tier (CFT) switch 130 that manages communication between the client-facing tier 102 and the private access network 166 and between the client-facing tier 102 and the private network 110. As shown, the CFT switch 130 is coupled to one or more data servers 132 that store data transmitted in response to user requests, such as video-on-demand material. The CFT switch 130 can also be coupled to a terminal server 134 that provides terminal devices, such as a game application server and other devices with a common connection point to the private network 110. In a particular embodiment, the CFT switch 130 can also be coupled to a video-on-demand (VOD) server 136.

The application tier 104 can communicate with both the private network 110 and the public network 112. In this embodiment, the application tier 104 can include a first application tier (APP) switch 138 and a second APP switch 140. In a particular embodiment, the first APP switch 138 can be coupled to the second APP switch 140. The first APP switch 138 can be coupled to an application server 142 and to an OSS/BSS gateway 144. The application server 142 provides applications to the set-top box devices 116 and 124 via the private access network 166, so the set-top box devices 116 and 124 can provide functions such as display, messaging, processing of IPTV data and VOD material. In a particular embodiment, the OSS/BSS gateway 144 includes operation systems and support (OSS) data, as well as billing systems and support (BSS) data.

The second APP switch 140 can be coupled to a domain controller 146 that provides web access, for example, to users via the public network 112. The second APP switch 140 can be coupled to a subscriber and system store 148 that includes account information, such as account information that is associated with users who access the system 100 via the private network 110 or the public network 112. In a particular embodiment, the application tier 104 can also include a client gateway 150 that communicates data directly to the client-facing tier 102. In this embodiment, the client gateway 150 can be coupled directly to the CFT switch 130. The client gateway 150 can provide user access to the private network 110 and the tiers coupled thereto.

In a particular embodiment, the set-top box devices 116 and 124 can access the system via the private access network 166 using information received from the client gateway 150. The private access network 166 provides security for the private network 110. User devices can access the client gateway 150 via the private access network 166, and the client gateway 150 can allow such devices to access the private network 110 once the devices are authenticated or verified. Similarly, the client gateway 150 can prevent unauthorized devices, such as hacker computers or stolen set-top box devices, from accessing the private network 110 by denying access to these devices beyond the private access network 166.

For example, when the set-top box device 116 accesses the system 100 via the private access network 166, the client gateway 150 can verify subscriber information by communicating with the subscriber and system store 148 via the private network 110, the first APP switch 138 and the second APP switch 140. Further, the client gateway 150 can verify billing information and status by communicating with the OSS/BSS gateway 144 via the private network 110 and the first APP switch 138. The OSS/BSS gateway 144 can transmit a query across the first APP switch 138, to the second APP switch 140, and the second APP switch 140 can communicate the query across the public network 112 to the OSS/BSS server 164. After the client gateway 150 confirms subscriber and/or billing information, the client gateway 150 can allow the set-top box device 116 access to IPTV content and VOD content. If the client gateway 150 cannot verify subscriber information for the set-top box device 116, such as because it is connected to a different twisted pair, the client gateway 150 can deny transmissions to and from the set-top box device 116 beyond the private access network 166.

The acquisition tier 106 includes an acquisition tier (AQT) switch 152 that communicates with the private network 110. The AQT switch 152 can also communicate with the operations and management tier 108 via the public network 112. In a particular embodiment, the AQT switch 152 can be coupled to a live acquisition server 154 that receives television content, for example, from a broadcast service 156. Further, the AQT switch can be coupled to a video-on-demand importer server 158 that stores television content received at the acquisition tier 106 and communicate the stored content to the client-facing tier 102 via the private network 110.

The operations and management tier 108 can include an operations and management tier (OMT) switch 160 that conducts communication between the operations and management tier 108 and the public network 112. In the illustrated embodiment, the OMT switch 160 is coupled to a TV2 server 162. Additionally, the OMT switch 160 can be coupled to an OSS/BSS server 164 and to a simple network management protocol (SNMP) monitor 167 that monitors network devices. In a particular embodiment, the OMT switch 160 can communicate with the AQT switch 152 via the public network 112.

In a particular embodiment during operation of the IPTV system, the live acquisition server 154 can acquire television content from the broadcast service 156. The live acquisition server 154 in turn can transmit the television content to the AQT switch 152 and the AQT switch can transmit the television content to the CFT switch 130 via the private network 110. Further, the television content can be encoded at the D-servers 132, and the CFT switch 130 can communicate the television content to the modems 114 and 122 via the private access network 166. The set-top box devices 116 and 124 can receive the television content from the modems 114 and 122, decode the television content, and transmit the content to the display devices 118 and 126 according to commands from the remote control devices 120 and 128.

Additionally, at the acquisition tier 106, the VOD importer server 158 can receive content from one or more VOD sources outside the IPTV system 100, such as movie studios and programmers of non-live content. The VOD importer server 158 can transmit the VOD content to the AQT switch 152, and the AQT switch 152 in turn can communicate the material to the CFT switch 130 via the private network 110. The VOD content can be stored at one or more servers, such as the VOD server 136.

When a user issues a request for VOD content to the set-top box device 116 or 124, the request can be transmitted over the private access network 166 to the VOD server 136 via the CFT switch 130. Upon receiving such a request, the VOD server 136 can retrieve requested VOD content and transmit the content to the set-top box device 116 or 124 across the private access network 166 via the CFT switch 130. In an illustrative embodiment, the live acquisition server 154 can transmit the television content to the AQT switch 152, and the AQT switch 152 in turn can transmit the television content to the OMT switch 160 via the public network 112. In this embodiment, the OMT switch 160 can transmit the television content to the TV2 server 162 for display to users accessing the user interface at the TV2 server. For example, a user can access the TV2 server 162 using a personal computer (PC) 168 coupled to the public network 112.

The domain controller 146 communicates with the public network 112 via the second APP switch 140. Additionally, the domain controller 146 can communicate via the public network 112 with the PC 168. For example, the domain controller 146 can display a web portal via the public network 112 and allow users to access the web portal using the PC 168. Further, in an illustrative embodiment, the domain controller 146 can communicate with at least one wireless network access point 178 over a data network 176. In this embodiment, each wireless network access device 178 can communicate with user wireless devices such as a cellular telephone 184.

In a particular embodiment, the set-top box devices can include an STB computer program 174 that is embedded within the STB memory device 172. The STB computer program 174 can contain instructions to receive and execute at least one user television viewing preference that a user has entered by accessing an Internet user account via the domain controller 146. For example, the user can use the PC 168 to access a web portal maintained by the domain controller 146 via the Internet. The domain controller 146 can query the subscriber and system store 148 via the private network 110 for account information associated with the user. In a particular embodiment, the account information can associate the user's Internet account with the second set-top box device 124. For instance, in an illustrative embodiment, the account information can relate the user's account to the second set-top box device 124 by associating the user account with an IP address of the second set-top box device, with data relating to one or more twisted pairs connected with the second set-top box device, with data related to one or more fiber optic cables connected with the second set-top box device, with an alphanumeric identifier of the second set-top box device, with any other data that is suitable for associating the second set-top box device with a user account, or with any combination of these.

The STB computer program 174 can contain instructions to receive many types of user preferences from the domain controller 146 via the access network 166. For example, the STB computer program 174 can include instructions to receive a request to record at least one television program at a video content storage module such as a digital video recorder (DVR) 182 within the second set-top box device 124. In this example embodiment, the STB computer program 174 can include instructions to transmit the request to the DVR 182, where the television program(s) are recorded. In an illustrative embodiment, the STB computer program 174 can include instructions to receive from the DVR 182 a recording status with respect to one or more of the television programs and to transmit at least one message regarding the status to a wireless device, such as the cellular telephone 184. The message can be received at the CFT switch 130, for instance, and communicated to the domain controller 146 across the private network 110 via the second APP switch 140. Further, the domain controller 146 can transmit the message to the wireless data network 176, directly or via the public network 112, and on to the wireless network access point 178. The message can then be transmitted to the cellular telephone 184. In an illustrative embodiment, the status can be sent via a wireless access protocol (WAP).

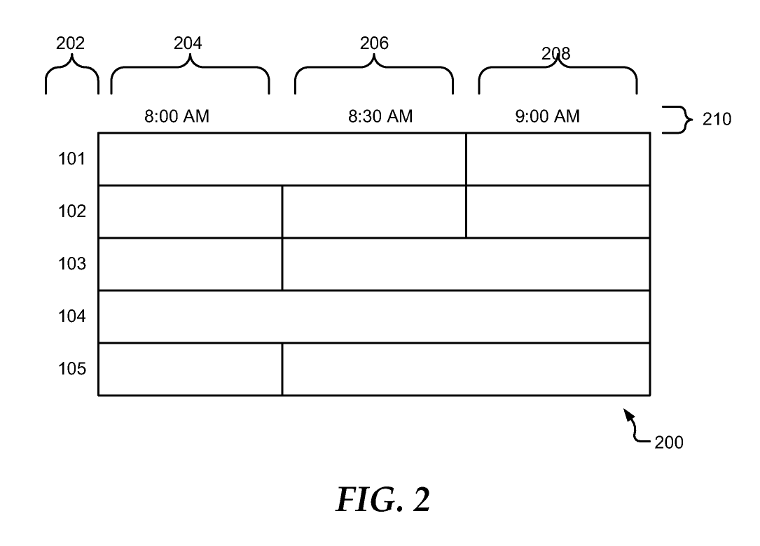

FIG. 2 shows an exemplary embodiment of an electronic programming guide (EPG) 200. The EPG 200 provides television viewers with on-screen television schedule information. EPG 200 may be displayed along with additional information, such as advertisements, detailed program descriptions, programming, or any combination thereof. The programming information is preferably displayed in a grid format, including columns 202 through 208. Column 202 displays the various channels. The list of channels may include all channels available, only those channels to which the viewer is subscribed, or a subset of favorite channels preselected by the viewer. Columns 204, 206, and 208 can indicate what is showing on the channels listed in column 202 in half hour increments. For example, titles of programs can be displayed within the columns 204, 206, and 208. Additionally, a brief description of the program may be displayed. For programs spanning multiple half hour increments, the title and description may be displayed across more than one of columns 204, 206, and 208. The time corresponding to the half hour increments is displayed in a row 210 across the top of EPG 200. Typically, more channels are available than can be shown at one time. Accordingly, the grid may be scrolled up or down through additional channels. Further, a viewer may scroll the grid to the left or right to view programming choices at different times.

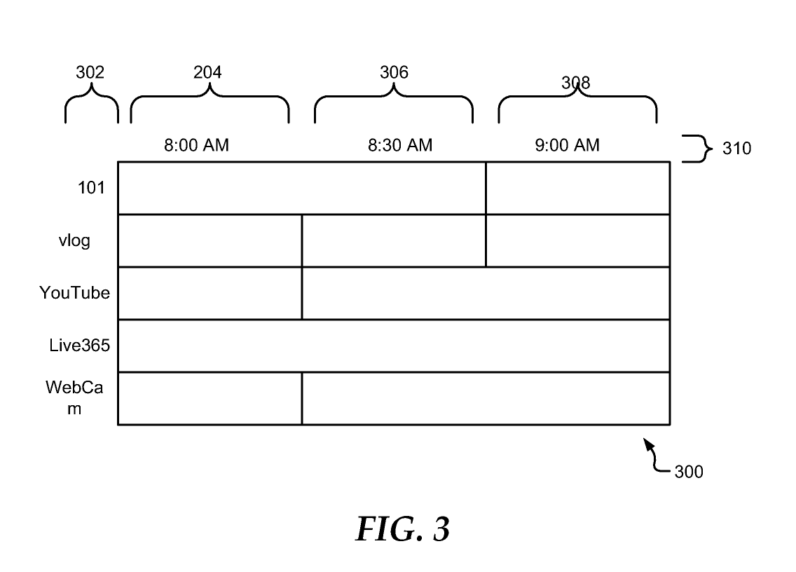

FIG. 3 shows an exemplary embodiment of an EPG 300. The EPG 300 provides television viewers with on-screen television schedule information and information about Internet content. The programming information is preferably displayed in a grid format, including columns 302 through 308. Column 302 displays the various channels. In addition to the available television channels, the list of sources may include Internet content channels corresponding to sources of internet content.

Internet content can include commercial content, viewer generated content, and personal content. Commercial content can be produced and made available on a commercial website. The content may be made available for free or it may be pay-per-view or require a paid subscription. For example, a television network may provide a limited number of free episodes to increase viewership and require a viewer to purchase additional episodes. Viewer generated content such as video or pictures may originate with the users of a website. Additionally, user generated content can include blogs. In addition to text, blogs can include photographs (photoblogs), video (vlogs), and audio (podcasts). Personal content can include Internet content that is restricted to a small number of users, such as a family photo and video album shared with friends and relatives. Personal content may require a user name and password or other form of authentication for access. Updates to Internet content may be accessible through web feed, such as an RSS feed or an Atom feed. The web feed allows users to easily determine if new content is available and identify which content is new.

In addition to the stored content discussed above, Internet content can include live content such as webcams, and webcasts such as Internet radio. Typically, webcams and webcasts provide a content stream to multiple users and a viewer may join a stream in progress, rather than starting at the beginning. In certain instances, the content may be archived and made available later as stored content. Alternatively, a set top box with DVR functionality may record a webcam or webcast for later viewing.

For television channels, columns 304, 306, and 308 can indicate what is showing on the channels listed in column 302 in half hour increments. The time corresponding to the half hour increments is displayed in a row 310 across the top of EPG 300. In an embodiment, information about the Internet content channel may be provided across columns 304, 306, and 308. For example, the title of a currently playing song may be displayed for Internet radio. Alternatively, the number of unviewed episodes and the title of the newest unviewed content may be displayed for web feeds, such as a podcast. In another embodiment, columns 304, 306, and 308 may each display an episode title of an unviewed episode, allowing the viewer to select an episode by selecting the episode title from one of columns 304, 306, or 308. The EPG 300 may scroll left or right to show additional episode titles and up and down to show additional content sources.

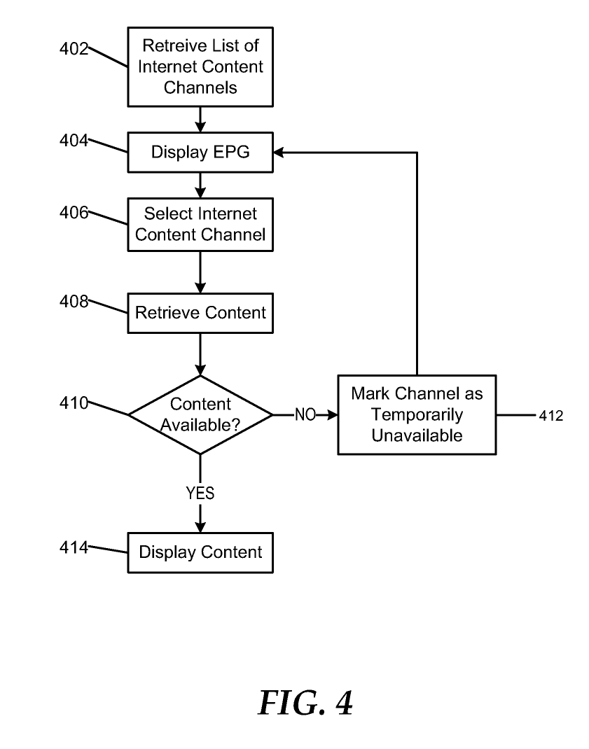

FIG. 4 shows an exemplary embodiment of a method for displaying information about Internet content within an EPG. At 402, a processor can retrieve a list of Internet content channels from a memory. The list may include Internet content channels added by the service provider such as a URL containing service announcements or special offers. Additionally, the viewer may add additional Internet content channels, such as a RSS feed from a favorite web site, a favorite streaming video channel, a favorite Internet radio broadcast, a relatives photo album, and the like. At 404, the list of Internet content channels can be displayed in the EPG, such as EPG 300. The EPG can include a channel identifier provided by the viewer or the service provider and a brief description of the content. The viewer may select an Internet content channel, as shown at 406. For example, the viewer may see that new photos have been added to the relative's photo album and select the photo album channel to view the new photos.

In an embodiment, the processor may provided parental controls to the Internet content channel. For example, a parent may restrict access to an Internet content channel to prevent children from viewing the Internet content channel, similar to the way a parent may block a television channel from being viewed. When an Internet content channel is restricted, an access code may be required to access the Internet content channel. Alternatively, the restricted Internet content channel may not be displayed within the EPG unless the access code has been provided. Additionally, the processor may use a rating system, such as Platform for Internet Content Selection (PICS), or other Internet content filtering techniques to identify locked content. In this way, parental control can be applied to the Internet content channels in a way that is similar to parental control of television channels.

At 408, the processor can request the content from a website. Alternatively, the processor may periodically check for new content on an Internet content channel. For example, the processor may retrieve a web feed from a website to identify any new content and cache the new content for later viewing. When the viewer selects the Internet content channel, the processor can retrieve the content from a local storage. At 410, if the content is not available, the processor can mark the channel as temporarily unavailable, as shown at 412. The processor may additional provide a notification to the viewer and return the viewer to the EPG. Alternatively, at 410, if the content is available, either locally or through the Internet, the processor can display the content for the viewer as shown at 416.

In an embodiment, the viewer may add additional Internet content channels by browsing web pages. For example, a web browser may identify websites having a web feed, such as an RSS feed. The web browser may provide an option to subscribe to the web feed. The viewer may be prompted for a channel identifier and the website can be added as an Internet content channel to the EPG. Alternatively, the website may provide a link to subscribe to the Internet content. The website may provide a default channel identifier or the viewer may provide the channel identifier.

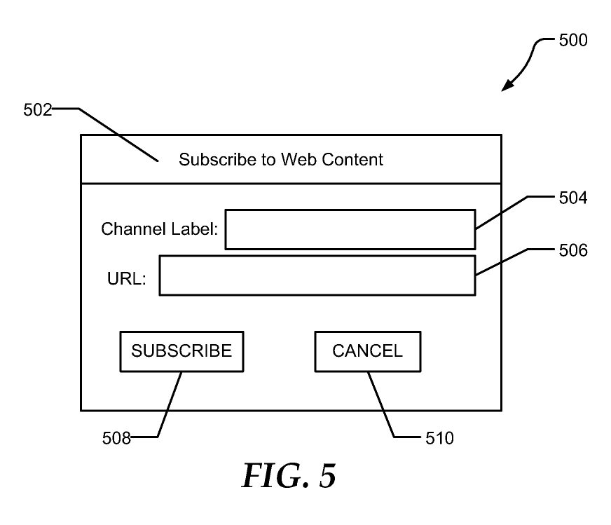

In another embodiment, the viewer may add additional Internet content channels by entering a URL. FIG. 5 shows an exemplary embodiment of an interface 500 to add an Internet content channel to the EPG, such as EPG 300, by entering a URL. The interface 500 includes a title bar 502, a channel label field 504, a URL field 506, and selection elements 508 and 510. A viewer may enter a channel label into channel label field 504 and a URL into URL field 506. The channel label may be displayed in the EPG to identify the content source. The viewer may select selection element 508 to subscribe to the Internet content source, or may select selection element 510 to return to a previous screen.

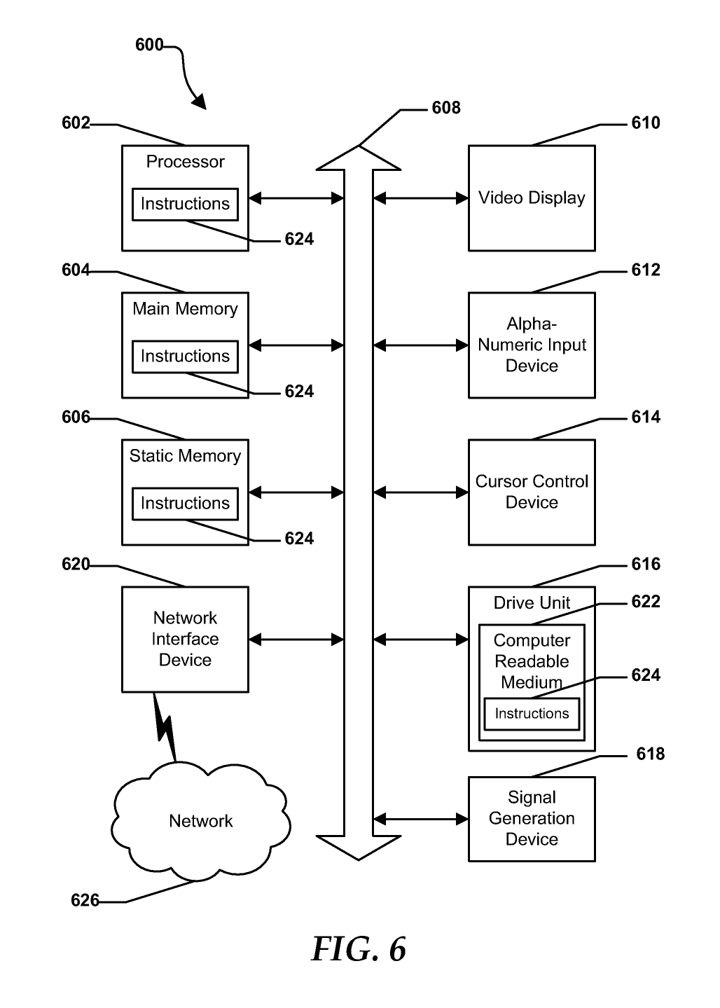

FIG. 6 shows an illustrative embodiment of a general computer system 600. The computer system 600 can include a set of instructions that can be executed to cause the computer system to perform any one or more of the methods or computer based functions disclosed herein. The computer system 600 may operate as a standalone device or may be connected, such as by using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 600 can also be implemented as or incorporated into various devices, such as a personal computer (PC), a tablet PC, an STB, a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 600 can be implemented using electronic devices that provide voice, video or data communication. Further, while a single computer system 600 is illustrated, the term “system” shall also be taken to include any collection of systems or sub-systems that individually or jointly execute a set, or multiple sets, of instructions to perform one or more computer functions.

The computer system 600 may include a processor 602, such as a central processing unit (CPU), a graphics processing unit (GPU), or both. Moreover, the computer system 600 can include a main memory 604 and a static memory 606 that can communicate with each other via a bus 608. As shown, the computer system 600 may further include a video display unit 610 such as a liquid crystal display (LCD), an organic light emitting diode (OLED), a flat panel display, a solid state display, or a cathode ray tube (CRT). Additionally, the computer system 600 may include an input device 612 such as a keyboard, and a cursor control device 614 such as a mouse. The computer system 600 can also include a disk drive unit 616, a signal generation device 618 such as a speaker or remote control, and a network interface device 620 to communicate with a network 626. In a particular embodiment, the disk drive unit 616 may include a computer-readable medium 622 in which one or more sets of instructions 624, such as software, can be embedded. Further, the instructions 624 may embody one or more of the methods or logic as described herein. In a particular embodiment, the instructions 624 may reside completely, or at least partially, within the main memory 604, the static memory 606, and/or within the processor 602 during execution by the computer system 600. The main memory 604 and the processor 602 also may include computer-readable media.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the FIGs. are to be regarded as illustrative rather than restrictive.

The Abstract of the Disclosure is provided to comply with 37 C.F.R. §1.72(b) and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. A set top box comprising:
a processor configured to
provide an electronic programming guide to available television programming; and
list content available from the Internet within the electronic programming guide.

2. The set top box of claim 1 wherein the content available from the Internet includes one of a streaming video channel, a vidcast, a podcast, a webcast, a Internet radio, a webcam, or any combination thereof.

3. The set top box of claim 1 further comprising a storage and the processor is further configured to store the content available from the Internet within the storage.

4. The set top box of claim 1 wherein the processor is further configured to display the content available from the Internet.

5. The set top box of claim 1 wherein the processor is further configured to maintain a viewer defined list of Internet sources.

6. The set top box of claim 5 wherein the processor is further configured to determine if new content is available from the Internet sources.

7. The set top box of claim 1 wherein the processor is further configured to restrict access to a portion of the content available from the Internet.

8. A method of providing an electronic programming guide, comprising:
gathering information about Internet content; and
listing the information in the electronic programming guide to available television programming.

9. The method of claim 8 wherein the Internet content includes one of a streaming video channel, a vidcast, a webcast, a Internet radio, a webcam, or any combination thereof.

10. The method of claim 8 further comprising recording the available content.

11. The method of claim 8 wherein further comprising displaying the available content on a television.

12. The method of claim 8 wherein further comprising restricting access to the available content.

13. A set top box comprising:
a processor configured to
check an Internet content channel for new content;
display the Internet content channel in an electronic programming guide to available television programming; and
indicate if any new content is available on the Internet content channel.

14. The set top box of claim 13 wherein the Internet content channel includes one of a streaming video channel, a vidcast, a webcast, a Internet radio, a webcam, or any combination thereof.

15. The set top box of claim 13 wherein the processor is further configured to record the new content from the Internet content channel.

16. The set top box of claim 13 wherein the processor is further configured to display the new content from the Internet content channel.

17. The set top box of claim 13 wherein the processor is further configured to restrict access to the Internet content channel.

18. A method comprising:
checking an Internet content channel for new content;
displaying the Internet content channel in an electronic programming guide to available television programming; and
indicating if any new content is available on the Internet content channel.

19. The method of claim 18 wherein the Internet content channel includes one of a streaming video channel, a vidcast, a webcast, a Internet radio, a webcam, or any combination thereof.

20. The method of claim 18 wherein the processor is further configured to record the new content from the Internet content channel.

21. The method of claim 18 wherein the processor is further configured to display the new content from the Internet content channel.

22. The method of claim 18 wherein the processor is further configured to restrict access to the Internet content channel.
